(19) United States
(12) Patent Application Publication
(10) Pub. No.: US 2018/0284953 A1
(43) Pub. Date: Oct. 4, 2018

(54) Image-Based Lighting Controller

(71) Applicants: Charles Brunault, South Hamilton, MA (US); Alan Sarkisian, Marblehead, MA (US)

(72) Inventors: Charles Brunault, South Hamilton, MA (US); Alan Sarkisian, Marblehead, MA (US)

(73) Assignee: OSRAM SYLVANIA Inc., Wilmington, MA (US)

(21) Appl. No.: 15/471,750

(22) Filed: Mar. 28, 2017

(51) Int. Cl. G06F 3/0482; H05B 37/02; G06F 3/0481

(52) U.S. Cl. CPC G06F 3/0482; H05B 37/0272; H04W 4/008; G06F 3/04815; G06F 3/04817

(57) ABSTRACT

Techniques are disclosed for controlling a remotely programmable light fixture using a mobile computing device in communication with the light fixture via a network. The device is configured to receive an image of an environment that includes the light fixture. Using the received image, the device is configured to generate a graphical user interface (GUI) based on the image. The GUI is configured to define an area of the image for selecting the light fixture. The defined area is associated with the light fixture and is configured to select the light fixture in response to a user input. The GUI is further configured to receive a selection of a light setting for the selected light fixture and transmit an adjustment of the light setting to the selected light fixture via the network.

### FIELD OF THE DISCLOSURE

This disclosure relates to lighting controllers, and more particularly to lighting controllers that are configured to generate a graphical user interface for controlling light fixtures using an image.

### BACKGROUND

As lighting systems have increased in sophistication, devices for remotely controlling lighting fixtures have been developed. Lighting controllers may adjust a given light fixture output to achieve various levels of lamp control. The different levels of lamp control may be adjusted in response to one or more user inputs received at the lighting controller. The manner in which user inputs are received by the lighting controller may vary greatly depending on a number of factors, such as the complexity of the system and/or the level of lamp control.

### SUMMARY

An example embodiment of the present disclosure provides a method for controlling a light fixture. The method includes receiving an image of an environment that includes the light fixture, generating a graphical user interface based on the image, associating an area of the image with the light fixture, receiving a selection of the area of the image associated with the light fixture via the graphical user interface, receiving a selection of a light setting for the selected light fixture via the graphical user interface, and transmitting an adjustment of the lighting setting to the light fixture based on the selection of the light setting.

In some embodiments, generating the graphical user interface may include determining a pixel coordinate location based on a number of pixels that receive a user input, determining a radius based on the number of pixels that receive the user input, and determining a size of the area associated with the light fixture based on the radius and the pixel coordinate location. In some embodiments, associating the area of the image with the light fixture includes receiving information from one or more light fixtures via a wireless network, identifying available light fixtures based on the received information, and correlating the area of the image with the light fixture based on a selection from the identified available light fixtures.

In some embodiments, associating the area of the image with the light fixture may include receiving a light fixture programming selection input via the graphical user interface, the light fixture programming selection input targeting the area of the image with the light fixture, receiving light fixture identifier information from the light fixture via a wireless communication link, and correlating the area of the image with the light fixture based on the light fixture identifier information. In some embodiments, receiving the light fixture programming selection input via the graphical user interface may be accomplished via a touch screen display or a mouse click. In some embodiments, receiving the light fixture programming selection input via the graphical user interface and receiving light fixture identifier information from the light fixture may occur simultaneously. In some embodiments, the wireless communication link may be a near field communication (NFC) link.

Another example embodiment of the present disclosure provides a system for controlling a light fixture. The system includes a mobile computing device, and a graphical user interface (GUI) executable on the mobile computing device and configured to control the light fixture. The GUI includes an image of an environment that includes the light fixture, in which an area of the image is associated with the light fixture such that the light fixture is selected in response to a user selection performed in the area, and a plurality of icons representing a plurality of light settings to be applied to the light fixture, in which the mobile computing device transmits an adjustment of a first light setting to the light fixture in response to a user selecting a first icon associated with the first light setting.

In some embodiments, the area may be defined by highlighting the light fixture captured in the image. In some embodiments, the area may be defined by a circle surrounding at least a portion of the light fixture captured in the image. In some embodiments, the area of the image is illuminated in response to a user input performed in the area. In some embodiments, the GUI may be further configured to allow for selection of two or more areas of the image in response to a line drawn on the image and around the two or more areas, in which each of the two or more areas is associated with a different light fixture. In such embodiments, the mobile computing device transmits the adjustment of the first light setting to each of the different light fixtures associated with the two or more areas in response to a user selecting the first icon associated with the first light setting.

Another example embodiment of the present disclosure provides a computer program product including one or more non-transitory machine readable mediums encoding a plurality of instructions that when executed by one or more processors facilitate operation of an electronic device according to a process. The mediums may be, for example, a disc-drive, solid-state drive, RAM, ROM, compact disc, thumb-drive, server computer, microcontroller on-board memory, or any other non-transitory memory. The process includes receiving an image of an environment that includes a light fixture, generating a graphical user interface based on the image, associating an area of the image with the light fixture, receiving a selection of the area of the image associated with the light fixture via the graphical user interface, receiving a selection of a light setting for the selected light fixture via the graphical user interface, and transmitting an adjustment of the lighting setting to the light fixture based on the selection of the light setting.

In some embodiments, generating the graphical user interface may include determining a pixel coordinate location based on a number of pixels that receive a user input, determining a radius based on the number of pixels that receive the user input, and determining a size of the area associated with the light fixture based on the radius and the pixel coordinate location. In some embodiments, associating the area of the image with the light fixture includes receiving information from one or more light fixtures via a wireless network, identifying available light fixtures based on the received information, and correlating the area of the image with the light fixture based on a selection from the identified available light fixtures.

In some embodiments, associating the area of the image with the light fixture may include receiving a light fixture programming selection input via the graphical user interface, the light fixture programming selection input targeting the area of the image with the light fixture, receiving light fixture identifier information from the light fixture via a wireless communication link, and correlating the area of the image with the light fixture based on the light fixture identifier information. In some embodiments, receiving the light fixture programming selection input via the graphical user interface may be accomplished via a touch screen display or a mouse click. In some embodiments, receiving the light fixture programming selection input via the graphical user interface and receiving light fixture identifier information from the light fixture may occur simultaneously. In some embodiments, the wireless communication link may be a near field communication (NFC) link.

The features and advantages described herein are not all-inclusive and, in particular, many additional features and advantages will be apparent to one of ordinary skill in the art in view of the drawings, specification, and claims. Moreover, it should be noted that the language used in the specification has been selected principally for readability and instructional purposes and not to limit the scope of the inventive subject matter.

### BRIEF DESCRIPTION OF THE DRAWINGS

FIG. 1A is a perspective view of an area configured in accordance with an embodiment of the present disclosure.

FIG. 1B is a perspective view of an area including a mobile computing device configured in accordance with an embodiment of the present disclosure.

FIG. 2 illustrates an image of the area that includes a lighting system configured in accordance with an embodiment of the present disclosure.

FIG. 3 is a front view of a graphical user interface configured in accordance with an example embodiment of the present disclosure.

FIG. 4 is a block diagram of a system configured in accordance with an embodiment of the present disclosure.

FIG. 5 is a flow chart of an example method for controlling a remotely programmable light fixture, in accordance with an embodiment of the present disclosure.

FIG. 6A illustrates a user input performed on an area of an image of a graphical user interface to select a light fixture, in accordance with an example embodiment of the present disclosure.

FIG. 6B illustrates a user input performed on an icon of a graphical user interface to select a light setting for the selected light fixture, in accordance with an example embodiment of the present disclosure.

FIG. 6C illustrates a user input performed on the image of a graphical user interface to select two light fixtures, in accordance with an example embodiment of the present disclosure.

These and other features of the present embodiments will be understood better by reading the following detailed description, taken together with the figures herein described. The accompanying drawings are not intended to be drawn to scale. For purposes of clarity, not every component may be labeled in every drawing.

### DETAILED DESCRIPTION

Techniques are disclosed for controlling a light fixture using a graphical user interface (GUI). The GUI is based on a photo-based image that includes the light fixture. In an embodiment, the GUI is programmed or otherwise configured to define an area of the image (e.g., the portion of the image displaying the light fixture) for selecting the light fixture to be controlled in response to receiving a user input, such as a press-and-hold or double tap gesture. In response, the GUI may receive a light fixture identifier corresponding to the light fixture. The identifier associates the light fixture with the defined area of the image, such that a user input received in the defined area selects the associated light fixture. This photo-based GUI allows a user to control the fixture, for example by selecting a different light setting. A light setting may be selected by performing a user input on an icon overlaid on the image or otherwise displayed in the GUI. In response, the GUI is configured to transmit instructions and/or commands to the selected light fixture to adjust the light fixture output based on the selected light setting. Numerous variations and embodiments will be appreciated in light of this disclosure.

### Overview

Lighting control systems may include a number of controllers for regulating the illumination of an environment. The controllers may include a GUI that provides lighting system information to a user via a virtual representation of the fixtures to be controlled, such as a listing of the devices or a schematic diagram of the lighting fixtures of a system. These virtual representations, however, are difficult to generate and generally requiring programming skill. Moreover, these representations may be improperly scaled and/or lack sufficient detail for a user to quickly recognize and understand the elements of the lighting system.

Thus, and in accordance with an embodiment of the present disclosure, techniques are disclosed for controlling a light fixture using a GUI based on an image of the area being illuminated. The image captures light fixtures included in the area. The GUI may be included, for example, on a mobile computing device, such as a smart phone, tablet or laptop, and configured to receive the image that includes a light fixture, although any computer system capable of presenting a GUI and receiving input via that GUI can be used. Upon receiving the image, the device determines or otherwise defines an area of the image to be associated with the light fixture. The defined area may be created by receiving a user input, such as a press-and-hold gesture, on an area of the image that includes the light fixture. In response, the GUI may be configured to determine the size and location of the defined area based on the pixels of the image that received the input. The defined area may be displayed on the image, for example, as a circle or formfitting line around the portion of the image that includes the light fixture.

Once created, each defined area can be associated with a corresponding light fixture by receiving light fixture data and/or a light fixture identifier (collectively light fixture information), from the light fixture and then relating that information to the defined area (e.g., the portion of the image that includes the light fixture). This association can be accomplished during the creation of the area or as a separate action. Light fixture information may be transmitted to the mobile computing device using near field communication (NFC) technology or wireless networks, such as Wi-Fi or ZIGBEE® networks. Light fixture identifiers may include, for example, images and/or identification numbers. Light fixture data, on the other hand, may include operational data, such as specifications and/or operating parameters. Upon receiving the light fixture information, the GUI may create a registry of available light fixtures based on the received information. The user may select a light fixture from the registry to be associated with the defined area.

The GUI also includes one or more icons that are displayed with the image, each icon being configured for selecting a light setting or navigating the interface, according to an embodiment. Light settings may include, but are not limited to, on-off, dim, color temperature and light color. The icons may also be configured to perform navigation functions such as, accessing lighting system options, settings and/or stored information (e.g., pre-saved images). The icons may be displayed over the image, such that the icon does not obscure or otherwise obstruct a defined area. The number of icons displayed with the image may vary depending on the application. In some applications, for example, the icons are displayed based on the selected light fixture (i.e., available light fixture functions). In other applications, the icons may be continuously displayed, but one or more icons may be disabled based a light fixture selection. In still other applications, the icons associated with navigating the interface may be continuously displayed, but the icons for selecting a light setting may be displayed non-continuously.

With the GUI generated, the light fixture and the light setting may be selected by performing a user input on a defined area and an icon (respectively). The user input, for example, may be a single tap gesture on the area followed by another single tap gesture on the icon. In response, the GUI is configured to transmit the light setting instructions and/or commands to the selected light fixture via a wired or wireless network or a combination thereof.

Example Lighting Application

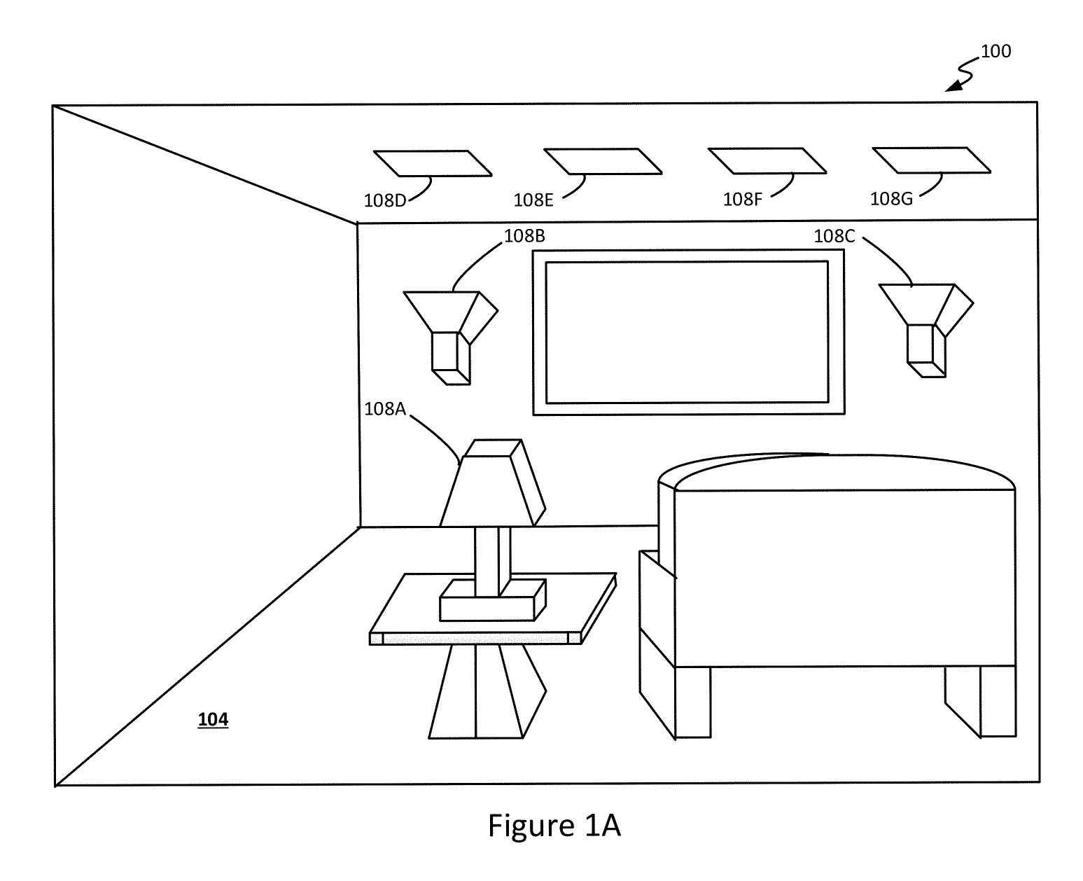

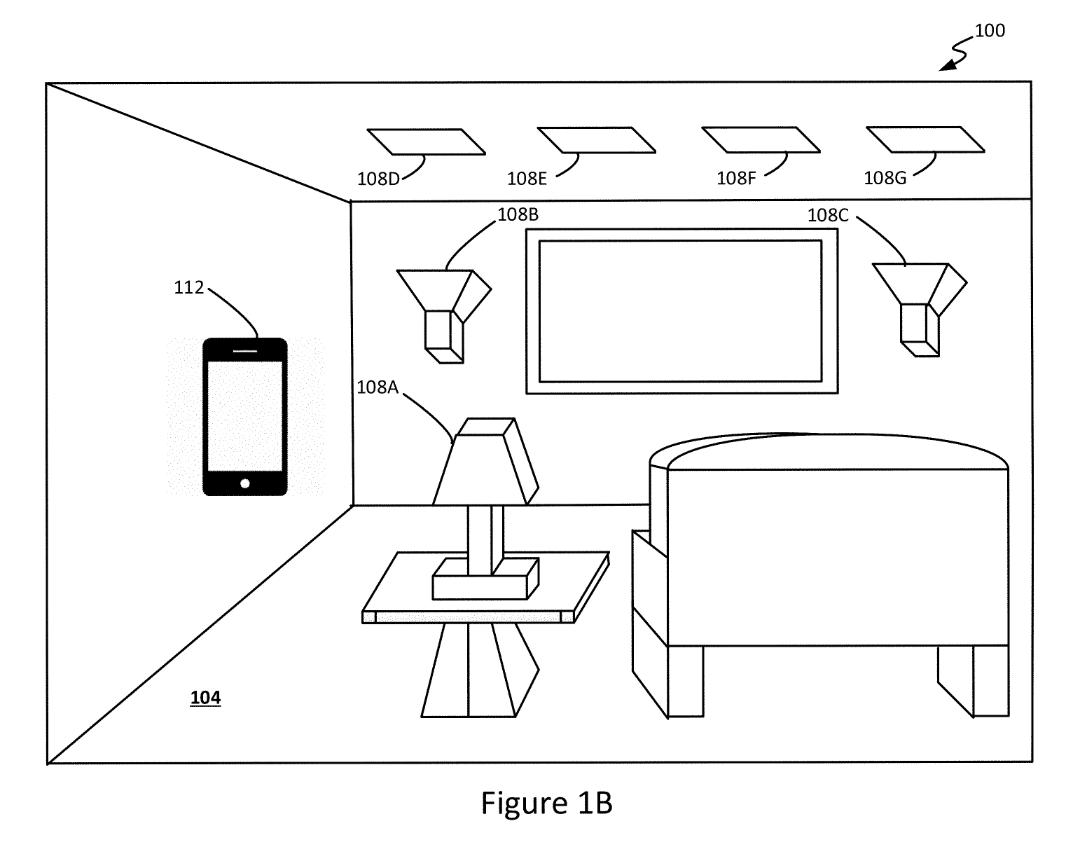

FIG. 1A is a perspective view of an environment 100, which can be any structure or area in which lighting systems are controlled using the techniques described herein. As can be seen, the environment 100 may be defined by a physical structure, such as a room 104 with four walls. In other cases, however, the environment 100 may be a particular space, such as the area of illumination about a light fixture.

As can be seen, the environment 100 may include various light fixtures (in this example, a table lamp 108A, wall sconces 108B and 108C, and recessed lights 108D through 108G), collectively referred to as light fixtures 108. The light fixtures 108 emit visible light to illuminate of the environment 100. In this case, the light fixtures 108 are remotely programmable light fixtures (as will be described further).

FIG. 1B is a perspective view of an environment 100, which may include a mobile computing device 112 for controlling the light fixtures 108. As a controller, the mobile computing device 112 is configured to present or otherwise display a GUI for controlling the light fixtures 108. Using this interface, a user can adjust one or more light settings for a selected light fixture 108. While a mobile computing device 112 is shown, it will be understood that any of the computing devices disclosed herein may be applied to embodiments described herein.

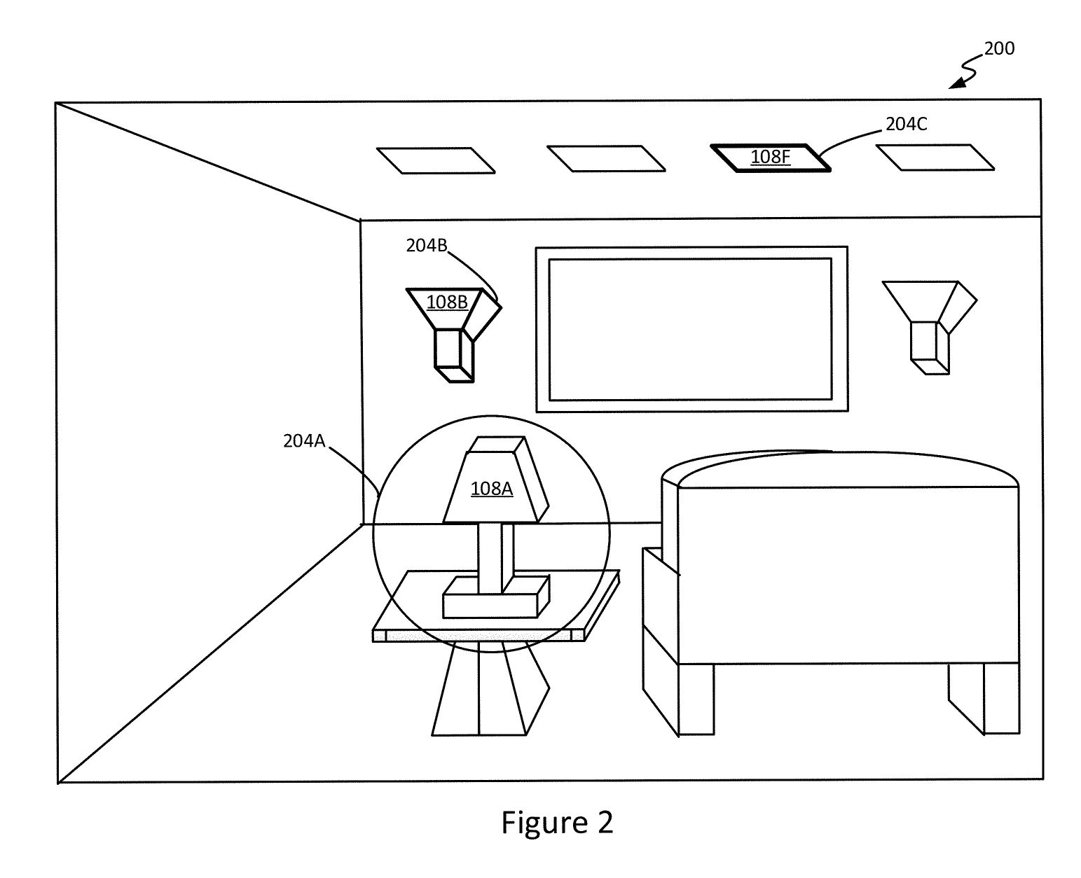

FIG. 2 is an image of the environment 100, configured in accordance with an embodiment of the present disclosure. The image 200 provides a visual illustration of light fixture locations within the environment 100 and is used to generate the control GUI. As part of the GUI, the image is configured to receive one or more inputs from a user at areas 204A, indicated by a circle, 204B and 204C, both of which are indicated by a formfitting line around the perimeter of the light fixture 108B and 108F, respectively. These defined areas are referred to collectively as areas 204. There may be additional areas 204 around each of the other light fixtures 108 in the image 200.

Each image 200 recorded and/or processed by the mobile computing device 112 has a width (x) and a height (y) based on the number of pixels of the image 200, hereinafter collectively called image resolution, which can be used to identify the location of the received user input within the image 200. In this case for instance, the image 200 may have a resolution of 840 by 630 pixels. The upper left hand corner of the image 200 is an origin location with coordinates of (0, 0) and upper right hand corner of the image 200 is the location of maximum width and height having coordinates of (840, 630). Using this coordinate system, the GUI may locate the position of a user input on the image 200, as described below.

As can be seen, the image 200 may be divided into areas 204A, 204B and 204C associated with one or more pixels for a given light fixture 108A, 108B and 108F respectively. Each of the areas 204 define a group of pixels that are configured as an interface for controlling a particular light fixture 108. Each of the areas 204 may be any size or shape sufficient to receive a user input.

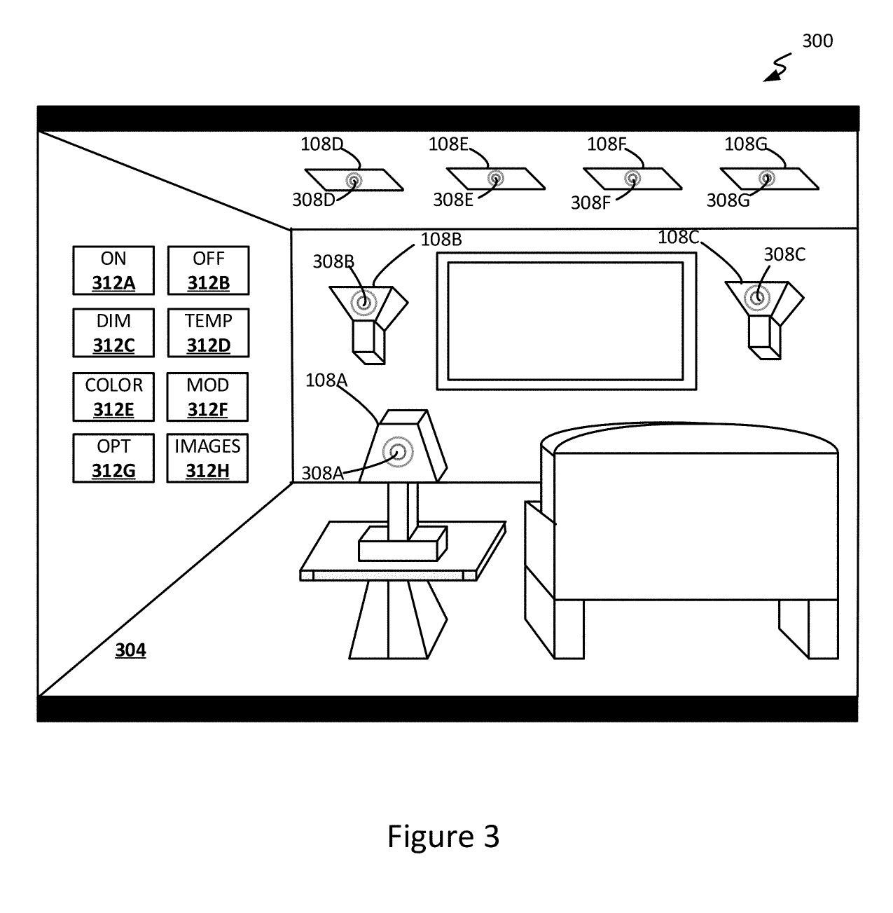

FIG. 3 illustrates a GUI 300 configured in accordance with an example embodiment of the present disclosure. The GUI 300 (as indicated by top and bottom solid borders and thus distinguished from the image 200 shown without borders) provides a user-friendly interface that allows for quick and easy recognition and selection of one or more light fixtures 108 within the environment 100. The GUI 300 includes an image 304, which includes areas 308A through 308G (collectively areas 308) for selecting light fixtures 108, and icons 312A through 312H (collectively icons 312) for selecting a light setting or navigation option. The image 304 and areas 308 may be analogous to the image 200 and the areas 204 that were previously described in relation to FIG. 2.

The GUI 300 includes icons 312 displayed over the image 304 and configured to initiate a pre-programmed lighting effect or navigate the GUI 300. The icons 312 may be displayed in any location or arrangement, such that the icons 312 do not obscure the areas 308. As can be seen, the icons 312 may be displayed in a grid pattern and positioned in a portion of the image that does not include a light fixture 108. In other instances, the icons 312 may be arranged in one or more rows along the top or bottom of the image 304. In yet other instances, the icons 312 may be sub-divided into icon groups, for example navigation and light setting, and each group of icons is located in a different portion of the image 304. Generally, the layout of the icons 312 may be configured in a number of ways as known in the art.

The displayed icons 312 are pre-programmed to execute light setting adjustments for a selected light fixture 108 or to navigate the GUI 300. For example, the icons 312A-F are configured to initiate a transmission of a set of instructions and/or commands via a network from the mobile computing device 112 to one or more of the light fixtures 108. These instructions may adjust a lighting output in a number of ways, including dimming (i.e., changing brightness), softening (i.e., changing color temperature), mixing (i.e., changing color), and/or modulating (e.g., flashing on and off). Other icons, such as icons 312G-H, are configured to navigate the GUI 300 to access user setting options and/or stored images. The icons 312 may include other functionalities not known in FIG. 3.

The instructions for adjusting a lighting output may specify a steady-state or a variable change to a lighting setting. For instance, the icon 312A may be configured to initiate instructions for turning on a selected light fixture 108. In other instances, the instructions may cause the light fixture 108 to provide a variable output to allow a user to select a desired lighting effect. For example, the dim icon 312C may be configured to transmit instructions that cause continuous adjustment in the lighting output for a selected light fixture 108 until another user input is received at one of the icon 312C, a defined area 308, or the image 304.

In other instances, the icons 312 are configured to provide a pre-determined light setting. For example, the dim icon 312C may be configured to transmit instructions to one of the light fixtures 108 for adjusting the brightness of a lighting output by ten percent of a maximum or current setting. To further adjust the brightness setting, the user may perform multiple inputs on the icon 312C for subsequent adjustments in ten percent increments. In other instances, the icon 312C may be configured to transmit instructions for automatically adjusting the light setting in ten percent increments. These instructions may also include a hold time (e.g., 5 or 10 seconds) for each light setting to allow a user an opportunity to observe the change and select the light setting.

As will be appreciated herein, any of the features shown in GUI 300 may be selected using any number of input mechanisms. For example, the GUI 300 may be presented to the user via a touch screen display, and the user may make selections by touching the various icons and images in the GUI 300. The touching may be direct or indirect (sufficiently proximate to the touch screen so as to be detectable by the computing device, but not actually touching the touch screen). For example, with the GUI 300 presented via a touch screen display, the user may tap or double tap or swipe across an icon 312 to select or otherwise engage the function associated with that icon. The computing device upon which the GUI 300 is operating may be programmed or otherwise configured to understand that tap to be on the location of the GUI 300 corresponding to the targeted icon, and to execute the function corresponding to that icon. Likewise, a user can press-and-hold on an area 308 of the image to associate that area 308 with the actual light fixture. The association can be carried out in a number of ways, as will be appreciated in light of this disclosure. For instance, the light fixtures 108 may be configured with a near field communication (NFC) tag that transmits a unique identifier or code when the NFC circuit of the computing device is placed near that light fixture 108. Thus, by simultaneously placing the computing device close to the imaged light fixture 108 while pressing the corresponding area 308 in the image, the computing device correlates the area 308 of the image with the light fixture 108 based on the unique identifier or code received via the NFC communication link. Alternatively, a pre-established table or other computing device memory that lists the available light fixtures 108 may be presented to the user in response to a press-and-hold on an area 308 of the image. The user may then select from the pre-established table the light fixture 108 corresponding to the selected area 308. Other user input mechanisms may be used as well. For instance, rather than a touch screen, the computing device may use a mouse and keyboard arrangement, a stylus, or other user suitable input mechanism. In such cases, selections of icons 312 and areas 308 and other features of GUI 300 can be made by clicks, double clicks, drawings, gestures, or other typical computer inputs. In short, the GUI 300 may be used in conjunction with any number of user interface mechanisms. Likewise, other communication links can be used, and the present disclosure is not intended to be limited to NFC links.

System Architecture and Operation

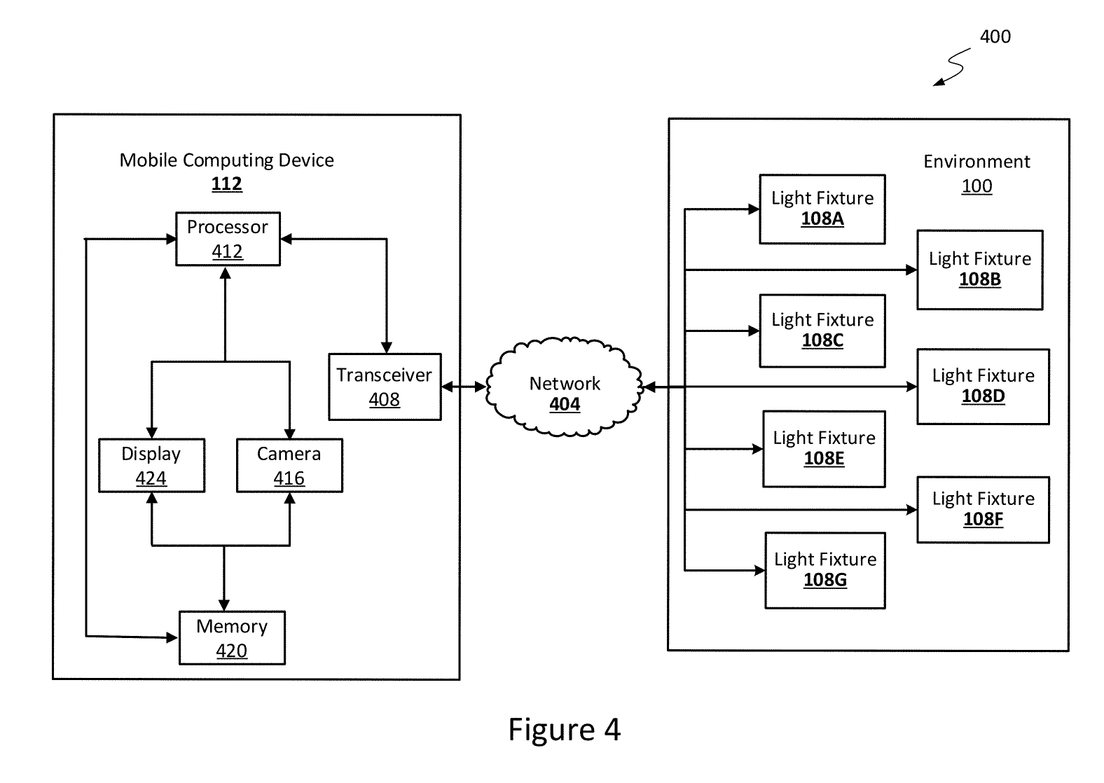

FIG. 4 is a block diagram of a system configured in accordance with an embodiment of the present disclosure. The system 400 includes an environment 100, a network 404, and a mobile computing device 112.

The environment 100 includes a number of light fixtures 108 that are remotely programmable. Remotely programmable light fixtures are configured to adjust a light setting based on information received from a remote source. Light fixtures 108 may be any electrical device that can create artificial light, each including one or more electric lamps. The light fixtures 108 include receivers (e.g., ZIGBEE® or Wi-Fi) for remotely controlling the fixtures using a communication signal transmitted via the network 404, for example, ZIGBEE® or LIGHTIFY® by OSRAM SYLVANIA®, although any number of suitable wireless communication links may be used as will be appreciated in light of this disclosure. In some instances, these receivers may be configured with near field communication or so-called NFC protocols that place the mobile computing device 112 in communication with the light fixture 108 in response to positioning the computing device 112 near the light fixture 108, for example, within 10 centimeters or some other relatively short distance suitable to establish a NFC communication link. In other instances, the mobile computing device 112 and light fixtures 108 may communicate via a network 404, as further described below.

The light fixtures 108 may include electric lamps that provide a variable lighting output, such as incandescent, compact fluorescent (CFL) and/or light emitting diode (LED) luminaires. To this end, any electric lamps may be used with the light fixtures 108 that are capable of adjusting their lighting characteristics, such as, brightness or color temperature. Color temperature, for example, may be adjusted by mixing the colors of the output of an electric lamp. Color combinations, such as red, green, and blue (i.e., primary colors) may be varied to create lighting outputs having different color temperatures. This is particularly convenient for electric lamps that include lighting elements that produce different colors, either directly (e.g., red, green, and blue light emitting LEDs) or indirectly (using color filters).

As can be seen, the light fixtures 108 may communicate with a mobile computing device 112 via one or more communication networks 404. The network 404 may be in communication with one or more light fixtures 108 and/or mobile computing devices 112. The network 404 may be a wireless local area network, a wired local network, or a combination of local wired and wireless networks, and may further include access to a wide area network such as the Internet or a campus-wide network. Some examples of the network 404 may include, for instance, Wi-Fi, ZIGBEE®, or LIGHTIFY® networks. In a more general sense, network 404 can be any communications network.

The light fixtures 108 located within the environment 100 may be controlled using a mobile computing device 112 that includes a GUI based on an image, as previously described. As discussed herein, the mobile computing device 112 may be configured to, in accordance with some embodiments: (1) record and/or process an image of the environment 100; (2) generate a GUI based on the image to control one or more light fixtures 108; and (3) adjust a light setting for one or more light fixtures 108 based on a user input. To these ends, mobile computing device 112 can be any of a wide range of computing platforms, mobile or otherwise. For example, in accordance with some embodiments, mobile computing device 112 can be, in part or in whole: (1) a laptop/notebook computer or sub-notebook computer; (2) a tablet or phablet computer; (3) a mobile phone or smartphone; (4) a personal digital assistant (PDA); (5) a portable media player (PMP); (6) a cellular handset; (7) a handheld gaming device; (8) a gaming platform; (9) a desktop computer; (10) a television set; (11) a wearable or otherwise body-borne computing device, such as a smartwatch, smart glasses, or smart headgear; and/or (12) a combination of any one or more thereof. Other suitable configurations for mobile computing device 112 may depend on a given application and will be apparent in light of this disclosure.

The mobile computing device 112 may further include or otherwise be operatively coupled to a transceiver 408 that receives and transmits communication signals to exchange information with other devices of the system 400 (e.g., the light fixtures 108). Transceiver 408 may be located within or otherwise operatively coupled with the mobile computing device 112 and configured with standard technology to facilitate communication with one or more other transceivers located inside and/or outside the environment 100. In some embodiments, the transceiver 408 is a modem, or other suitable circuitry that allows for transmitting and receiving data from the network 404. The communication signals may contain a variety of information, for example protocol information, images, and light setting commands and/or instructions. The mobile computing device 112 may receive and/or transmit this information via the network 404. In the example embodiment shown, the transceiver 408 may then communicate this information to a processor 412 of the mobile computing device 112, which in turn is programmed or otherwise configured to compile and distribute instructions and data to the light fixtures 108.

In some embodiments, the processor 412 may be configured to record and/or otherwise process image data to generate a GUI. Image data may be recorded using a camera 416 operatively coupled to the processor 412. The camera 416 may be any digital camera configured using standard technology, such as CMOS or CCD sensors. Data created and/or managed by the processors 412 may be stored within a memory 420 and presented to a user via a display 424 to support various operations of the mobile computing device 112 and/or the GUI. In some cases, the display 424 is s touch screen display, although it need not be, as will be appreciated in light of this disclosure. Memory 420 may be any physical device capable of non-transitory data storage, such as read only memory (ROM) or random access memory (RAM).

The processor 412 may be further configured to execute protocols and other instructions for one or more units of the GUI. A unit is a set of routines for generating and/or operating the GUI. The GUI may include a network discovery service unit and a lighting command and control service unit.

A network discovery service unit is a set of routines and/or protocols that when executed locate lighting sources (i.e., light fixtures 108) connected through the network 404. The network discovery service module allows the mobile computing device 112 to quickly and efficiently connect to one or more light fixtures 108 within the environment 100. The module may be initiated automatically or manually. When a mobile computing device 112 connects to the network 404, for example, the network discovery unit may automatically locate the light fixtures 108 in the environment 100 through the network 404. In other instances, a user may manually initiate the unit, for example, by performing a double tap gesture on the image. With the light sources located, the unit creates a registry of light fixture information and stores the information in the memory 420. In this instance, once the user selects an area by performing an input on the image, the GUI may be configured to display a menu (created from the light fixture information stored in the memory 420) to allow the user to select a particular light fixture to be associated with the selected area. The input may be, for example, a press-and-hold gesture on a touch screen display, or a double tap gesture on a touch screen display, or click of a mouse of a non-touch display computing system.

The GUI also includes a command and control service unit that facilitates the selection and transmission of one or more light setting commands to the light fixtures 108. The command and control service unit is a set of routines and/or protocols that when executed initiate a change to one or more light fixtures 108 based on a selected light setting. In an example case, the unit may be configured to initiate a light setting change in response to a user input (e.g., a single tap gesture) performed on an icon of the GUI.

The command and control service unit may be further configured to display icons within the GUI to enable a user to select a light setting. The unit may display all or some of the available icons to the user. In some further embodiments, the number of icons displayed may be determined based on the functionality of the selected light fixture. For example, when a selected light fixture cannot be adjusted for brightness then the dim icon may not be displayed. In other alternative embodiments, the dim icon may be displayed but is disabled to indicate to the user that the selected light fixture cannot be adjusted using that option.

Methodology

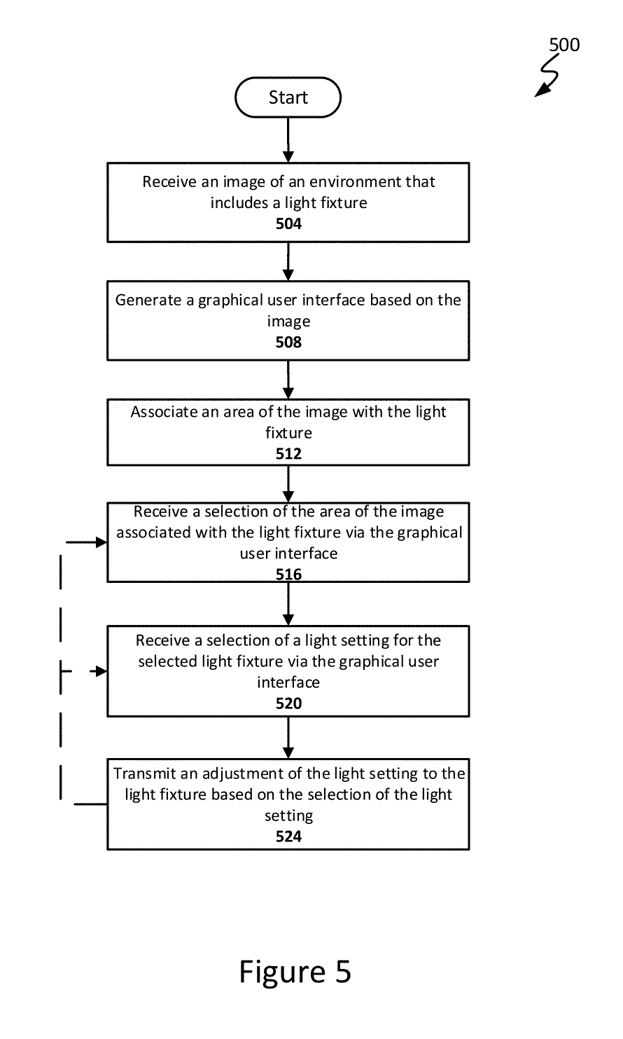

FIG. 5 is a flowchart showing a method 500 for controlling a remotely programmable light fixture, in accordance with an embodiment of the present disclosure. The method 500 may be performed by a processor (e.g., the processor 412) of a mobile computing device (e.g., the mobile computing device 112). The method 500 includes receiving an image of an environment that includes a light fixture in block 504. The image, in some instances, may be created or captured using a camera of the mobile computing device (e.g., the camera 416). In other instances, however, the image may be a pre-saved image that was created by another device and subsequently transmitted to the mobile computing device via a network (e.g., the network 404).

The method 500 further includes generating a GUI based on the image in block 508. As previously described, using an image rather than a virtual representation of the environment increases system efficiency and provides for an improved user experience. The mobile computing device may be configured to generate a GUI that includes: (1) an area of the received image associated with a light fixture and (2) an icon displayed over the image and configured to execute a pre-programmed light setting (e.g., turning lights on or off) corresponding to a selected light fixture.

The GUI may be generated by first defining an area of the received image to be associated with a light fixture based on a user input. A user input can be any input that is received or detected by one or more pixels of the image. The receiving pixels can be used to define an area associated with the light fixture, as described below. In an example case, the user input may be a gesture, such as pressing or tapping, performed on an area of the image. The user input may include more than one gesture, such as a double or triple tap. To distinguish between other user inputs, the area may be defined in response to maintaining the user input (e.g., a press and hold gesture) for period of time, such as three seconds. In some cases, however, the user input may be performed using a stylus or multiple-point gesture.

In some embodiments, the pixels for defining the area of the image may not be identified based on a user input. Rather, the pixels may be automatically identified based on pixel intensity values. Pixel intensity values correspond to light energy received by the image capturing device (e.g., a digital camera) for creating the image. Each pixel is assigned an intensity value based on light received from the light sources (e.g., a light fixture) within the device's field of view. Pixels having high intensity values (i.e., pixel intensity values being greater than intensity values for surrounding pixels) and within a closely compact region of the image indicate that a light fixture is present in the image because light fixtures produce higher intensity light as compared with ambient light of the surrounding environment. Thus, those pixels with higher intensity values (i.e., the pixels representing the light fixture) are selected for defining the area of the image to be associated with a light fixture.

With the user input received, an area of the image may be defined. In an example case, a pixel coordinate location is used to define the area of the image associated with a light fixture. As previously described, the image includes a number of pixels corresponding to specific locations within the image. A pixel coordinate location therefore, is a specific location within the image (e.g., (340,385)). The pixel coordinate location can be determined in one of several ways. One way is to calculate a center pixel based on an average location for the group of pixels receiving the user input. In other ways, the center pixel may be calculated using standard deviation or other statistical analysis.

As previously described, the defined area may be large enough to accurately receive a user input, but not so large as to include more than one light fixture. To ensure the proper size of the area, the area may be defined using a pixel radius about the pixel coordinate location (e.g. a center pixel). In this instance, the pixel radius may be defined by the distance between the pixel coordinate location and the receiving pixel located at the largest distance away from the pixel coordinate. In other instances, however, the pixel radius may be a pre-determined length, such as 1, 2, 5 or 10 pixels, depending on the spacing between light fixtures within the image.

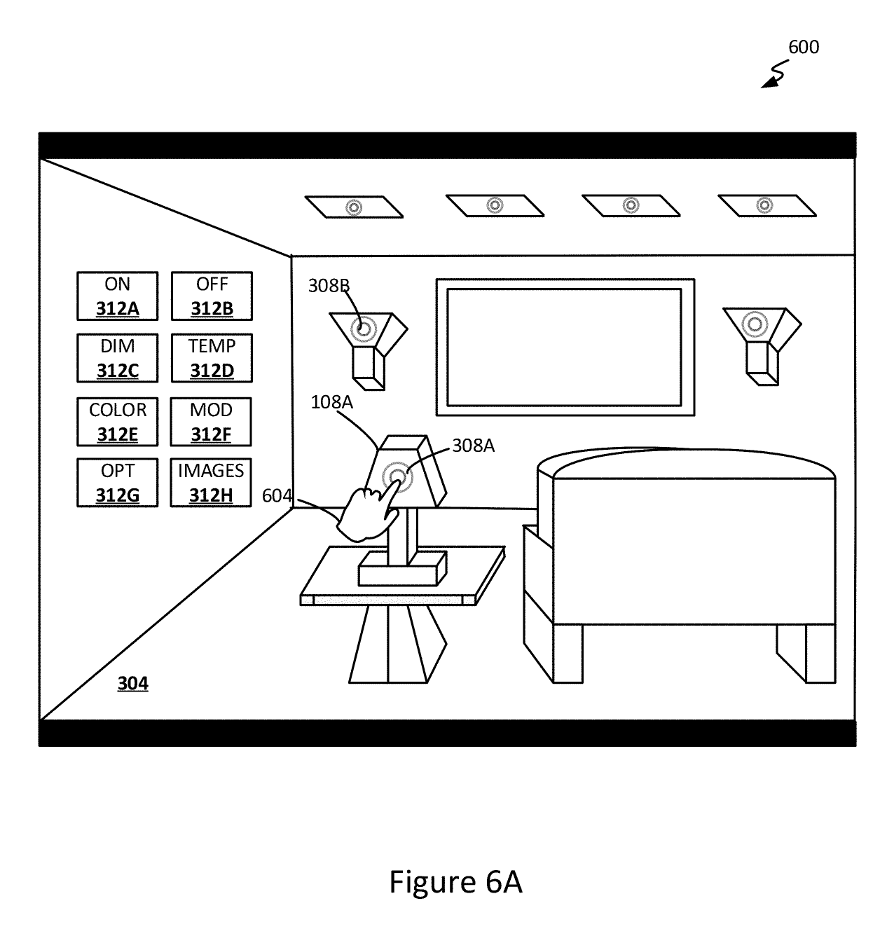

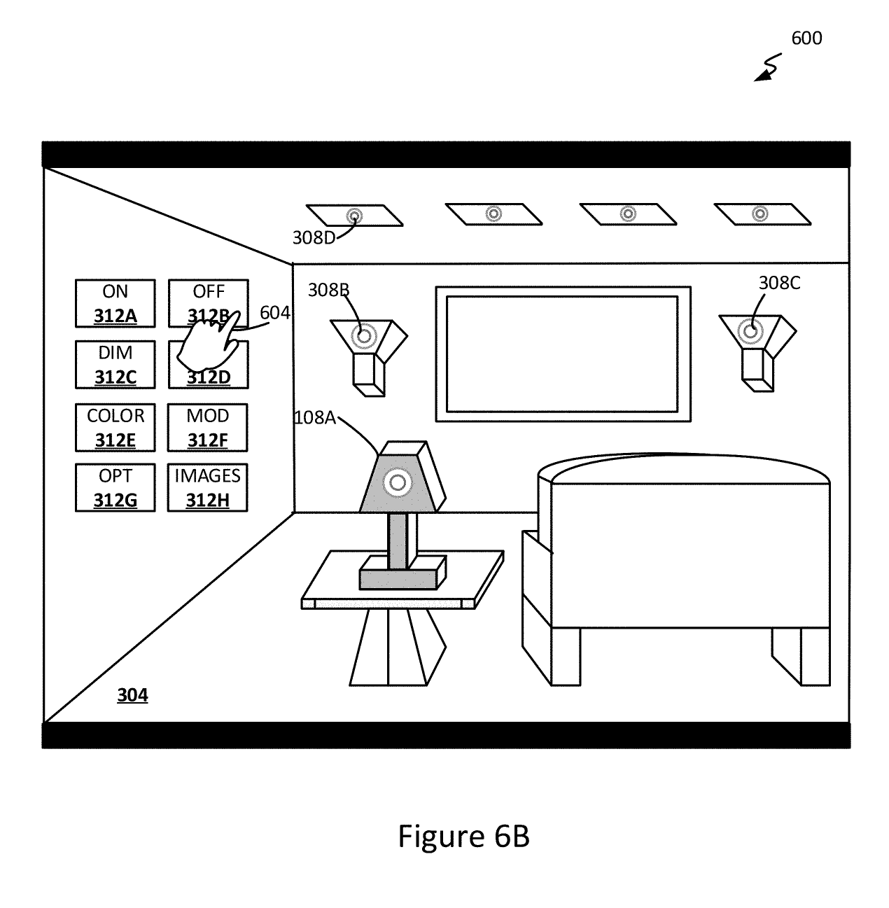

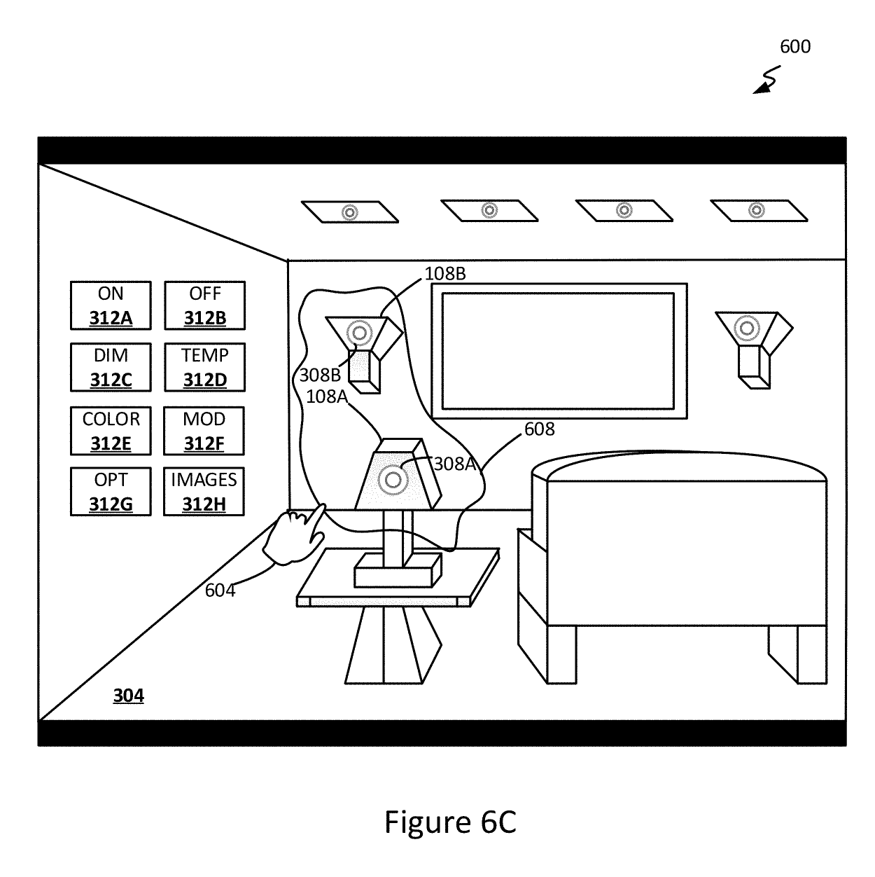

The GUI may be further configured to present or otherwise display icons to allow a user to initiate or activate a pre-programmed lighting effect. In an example embodiment, the icons may be displayed in response to a selection of a light fixture. This is illustrated in FIG. 6A, in which icons 312 are displayed over image 304 within a GUI 600. The icons 312 may be continuously displayed in response to a selection of a light fixture (e.g., 108A), as previously described.

The method 500 further includes associating an area of the image with the light fixture in block 512. By associating or otherwise correlating an area of the image with a light fixture, the GUI is configured to select one light fixture out of a possible number of light fixtures within a given environment in response to a user input within the area displayed in the GUI. The area is associated with a given light fixture based on received light fixture data. In an example case, the area and given light fixture are associated by the network discovery service unit, as previously described. Once the unit is initiated (e.g., performing a double tap gesture in an area of the image) the mobile computing device may receive light fixture identifiers and/or data to identify a particular light fixture within the environment. In this case, light fixture information is received using near field communication technology. Upon receipt of the light fixture information, the user may select a desired light fixture to be associated with the selected area from a menu displayed in the GUI.

The method 500 further includes receiving a selection of the area of the image associated with the light fixture via the GUI in block 516. A light fixture is selected when a user input (as previously described) is received in the defined area of the image associated with a light fixture. This is illustrated in FIG. 6A, in which a user 604 selects light fixture 108A by performing a single tap gesture within the area 308A. In some embodiments, such a selection may be indicated to a user by illuminating (e.g., increasing intensity values for pixels within the defined area of the image) or otherwise changing one or more display characteristics of the light fixture image and/or defined area. In some instances, the user may select multiple light fixtures by performing a user input on more than one area of the image (e.g., performing a gesture over areas 308A and 308B) prior to selecting a light setting via one of the displayed icons 312.

The method 500 further includes receiving a selection of a light setting for the selected light fixture via the GUI in block 520. A lighting effect or setting is selected when a user input (e.g., a single or multi-point gesture) is received by one of the displayed icons. This is illustrated in FIG. 6B, in which the user 604 selects the icon 312B configured to turn off the selected light fixture 108A (as indicated by the shaded light fixture image) by performing a single tap gesture on the icon 312B. In some embodiments, such a selection may be indicated to a user by illuminating or otherwise changing one or more display characteristics of the icon. In some instances, once the icon (e.g., the icon 312B) is selected the light fixture 108A is de-selected to enable a user to make another light fixture selection. In other instances, the light fixture 108A remains selected upon selecting a first light setting (e.g., turn on lights) to allow the user to select a second light setting (e.g., dim lights) for the same light fixture. Once one or more light settings have been selected for a light fixture, the user may de-select the light fixture (i.e., 108A) by performing a user input anywhere in the image, including an area corresponding to another light fixture (e.g., areas 308B, 308C or 308D).

The method 500 further includes transmitting an adjustment of the light setting to the light fixture based on the selection of the light setting in block 524. In one instance, the selected light setting is transmitted in response to a user input (e.g., a single tap gesture) performed on an icon. The GUI, in response, is configured to transmit pre-programmed instructions associated with the selected icon to change a light setting for a selected light fixture, as previously described. In some embodiments, after transmitting the adjustment of the light setting to the light fixture the method 500 may return to block 516 or block 520 to receive a selection of another light fixture by the user or the selection of another light setting for the same light fixture by the user.

Alternative Configurations

A number of embodiments are be apparent in light of the present disclosure. For instance, users may desire to select more than one light fixture at one time (e.g., when a user first enters a room). To save time and improve the user experience, the GUI may be configured to select two or more light fixtures at one time in response to a single user input. This is illustrated in FIG. 6C, in which a user 604 has provided a user input 608. The input 608 in this instance is a line drawn about light fixtures 108A and 108B. In response, the GUI is configured to identify and select all the defined areas (i.e., 308A and 308B) within the user input 608. The user 604 may then select a light setting using the icons 312 causing a transmission of instructions and/or commands to be transmitted to both light fixtures 108A and 108B. In this instance, the number of available light settings (i.e., displayed icons) may be limited to those settings associated with the light fixture having the fewest adjustment options, as previously described.

In some other embodiments, the system may include a gateway device to convert communication signals for two or more devices (e.g., the mobile computing device and the light fixture) having different communication components (e.g., Wi-Fi and ZIGBEE®). The gateway device, in this instance, allows more computing devices to use the image-based GUI because the gateway enables many different mobile computing devices (having different communication technologies) to communicate with the light fixtures of an environment regardless of the technology implemented in the fixtures. For example, the mobile computing device may be Wi-Fi enabled while the light fixtures may include ZIGBEE® network receivers. In this case, the gateway device is configured to change the network protocols of the Wi-Fi signal to ZIGBEE® signal protocols that can be received and/or recognized by the light fixtures.

In yet further embodiments, the GUI may be configured to disable or remove areas from the image to prevent inadvertent changes to a light setting. In such an embodiment, the interface may be configured to disable one or more defined areas associated with a light fixture in response to a disable gesture (e.g., a triple tap gesture) performed over one of those areas. For instance, the disable function may be performed on one defined area of the image associated with a light fixture, but may disable all the defined areas present so as to lock all the defined areas to prevent an inadvertent input. To unlock the areas, the user may perform the disable gesture (e.g., the triple tap gesture) over any one of the areas associated with a light fixture to unlock all the areas of the image. In some other instances, the disable gesture may also present a dialogue window requesting whether the user would like to delete the area from the image.

The foregoing description of the embodiments of the present disclosure has been presented for the purposes of illustration and description. It is not intended to be exhaustive or to limit the present disclosure to the precise form disclosed. Many modifications and variations are possible in light of this disclosure. It is intended that the scope of the present disclosure be limited not by this detailed description, but rather by the claims appended hereto.

What is claimed is:

1. A method for controlling a light fixture, the method comprising:
receiving an image of an environment that includes the light fixture;
generating a graphical user interface based on the image;
associating an area of the image with the light fixture;
receiving a selection of the area of the image associated with the light fixture via the graphical user interface;
receiving a selection of a light setting for the selected light fixture via the graphical user interface; and
transmitting an adjustment of the lighting setting to the light fixture based on the selection of the light setting.

2. The method of claim 1, wherein generating the graphical user interface comprises:
determining a pixel coordinate location based on a number of pixels that receive a user input;
determining a radius based on the number of pixels that receive the user input; and
determining a size of the area associated with the light fixture based on the radius and the pixel coordinate location.

3. The method of claim 1, wherein associating the area of the image with the light fixture comprises:
receiving information from one or more light fixtures via a wireless network;
identifying available light fixtures based on the received information; and
correlating the area of the image with the light fixture based on a selection from the identified available light fixtures.

4. The method of claim 1, wherein associating the area of the image with the light fixture comprises:
receiving a light fixture programming selection input via the graphical user interface, the light fixture programming selection input targeting the area of the image with the light fixture;
receiving light fixture identifier information from the light fixture via a wireless communication link; and
correlating the area of the image with the light fixture based on the light fixture identifier information.

5. The method of claim 4, wherein receiving the light fixture programming selection input via the graphical user interface is accomplished via a touch screen display or a mouse click.

6. The method of claim 4, wherein receiving the light fixture programming selection input via the graphical user interface and receiving light fixture identifier information from the light fixture occur simultaneously.

7. The method of claim 4, wherein the wireless communication link is a near field communication (NFC) link.

8. A system for controlling a light fixture, the system comprising:
a mobile computing device; and
a graphical user interface (GUI) executable on the mobile computing device and configured to control the light fixture, the GUI comprising:
an image of an environment that includes the light fixture, wherein an area of the image is associated with the light fixture such that the light fixture is selected in response to a user selection performed in the area; and
a plurality of icons representing a plurality of light settings to be applied to the light fixture, wherein the mobile computing device transmits an adjustment of a first light setting to the light fixture in response to a user selecting a first icon associated with the first light setting.

9. The system of claim 8, wherein the area is defined by highlighting the light fixture captured in the image.

10. The system of claim 8, wherein the area is defined by a circle surrounding at least a portion of the light fixture captured in the image.

11. The system of claim 8, wherein the area of the image is illuminated in response to a user input performed in the area.

12. The system of claim 8, wherein the GUI is further configured to allow for selection of two or more areas of the image in response to a line drawn on the image and around the two or more areas, wherein each of the two or more areas is associated with a different light fixture.

13. The system of claim 12, wherein the mobile computing device transmits the adjustment of the first light setting to each of the different light fixtures associated with the two or more areas in response to a user selecting the first icon associated with the first light setting.

14. A computer program product comprising one or more non-transitory machine readable mediums encoding a plurality of instructions that when executed by one or more processors facilitate operation of an electronic device according to a process, the process comprising:
receiving an image of an environment that includes a light fixture;
generating a graphical user interface based on the image;
associating an area of the image with the light fixture;
receiving a selection of the area of the image associated with the light fixture via the graphical user interface;
receiving a selection of a light setting for the selected light fixture via the graphical user interface; and
transmitting an adjustment of the lighting setting to the light fixture based on the selection of the light setting.

15. The computer program product of claim 14, wherein generating the graphical user interface comprises:
determining a pixel coordinate location based on a number of pixels that receive a user input;
determining a radius based on the number of pixels that receive the user input; and
determining a size of the area associated with the light fixture based on the radius and the pixel coordinate location.

16. The computer program product of claim 14, wherein generating the graphical user interface comprises:
receiving information from one or more light fixtures via a wireless network;
identifying available light fixtures based on the received information; and
correlating the area of the image with the light fixture based on a selection from the identified available light fixtures.

17. The computer program product of claim 14, wherein associating an area of the image with the light fixture comprises:
receiving a light fixture programming selection input via the graphical user interface, the light fixture programming selection input targeting the area of the image with the light fixture;
receiving light fixture identifier information from the light fixture via a wireless communication link; and
correlating the area of the image with the light fixture based on the light fixture identifier information.

18. The computer program product of claim 17, wherein receiving the light fixture programming selection input via the graphical user interface is accomplished via a touch screen display or a mouse click.

19. The computer program product of claim 17, wherein receiving the light fixture programming selection input via the graphical user interface and receiving light fixture identifier information from the light fixture occur simultaneously.

20. The computer program product of claim 17, wherein the wireless communication link is a near field communication (NFC) link.
